(19) United States
(12) Patent Application Publication
(10) Pub. No.: US 2016/0288343 A1
(43) Pub. Date: Oct. 6, 2016

(54) BOX CUTTER STRUCTURE

(71) Applicant: HACKSAW & KNIFE MANUFACTORY CO., LTD., Taichung City (TW)

(72) Inventors: Yin-Han Huang, Taichung City (TW); Tien-Yu Huang, Taichung City (TW)

(21) Appl. No.: 14/679,766

(22) Filed: Apr. 6, 2015

(51) Int. Cl. B26B 1/08

(52) U.S. Cl. CPC B26B 1/08

(57) ABSTRACT

A box cutter structure is provided, including a shell, having a blade-projecting end and a restriction portion; a blade carrier, slidably disposed in the shell for carrying a blade, having a pushed portion; a pushing assembly, disposed on the shell, being operable from outside the shell to move between a locking position and a releasing position, having an pushing portion and a blocking portion; wherein, when the pushing assembly is in the locking position, the restriction portion blocks a path along which the blocking portion moves toward the blade-projecting end, and the blade is unprojectable out of the blade-projecting end; when the pushing assembly is in the releasing position, the restriction portion is not on a path along which the blocking portion moves toward the blade-projecting end, and the blade is projectable out of the blade-projecting end.

### BACKGROUND OF THE INVENTION

1. Field of the Invention

The present invention relates to a cutting tool, and more particularly to a box cutter structure.

2. Description of the Prior Art

Usually, a box cutter is light, sharp and convenient to cut objects, and the box cutter is widely used. The conventional box cutter generally includes a long blade carrier, a blade disposed on the blade carrier and a controller which can be pushed and pulled by a user's finger. Through the user's finger pushing or pulling the controller, the controller controls the blade to move forward or backward inside the blade carrier; that is, the blade can be moved forward to project an edge out of the blade carrier, or the blade can be moved backward to retreat back to the blade carrier. The above-mentioned structure is disclosed in TWM 487191 and TWM 435984.

However, in this conventional structure, the user has to push and pull the controller by finger when using the box cutter. In addition, during a cutting process, a position-restricting structure (for example, a toothed slot) of the blade carrier needs to be stuck with the controller to restrict each other, and after use of the box cutter, the user needs to move the controller and release the controller and the position-restricting structure so as to retreat the blade. Moreover, the controller is an integrally formed member, and the blade is assembled on the controller; therefore, once the controller and the position-restricting structure are not stuck with each other, the blade is movable, and the user may be cut accidentally.

In addition, in this conventional structure, the blade does not retreat automatically after use. It is dangerous that the blade does not retreat into the blade carrier immediately.

The present invention has arisen to mitigate and/or obviate the afore-described disadvantages.

### SUMMARY OF THE INVENTION

The major object of the present invention is to provide a box cutter structure which projects a blade after a limitation of a pushing assembly is disarmed and retreats the blade automatically to prevent a user from danger.

To achieve the above and other objects, a box cutter structure of the present invention is provided, including: a shell, having a blade-projecting end and a restriction portion; a blade carrier, slidably disposed in the shell and provided for carrying a blade, having a pushed portion; a pushing assembly, disposed in the shell, being operable from outside the shell to move between a locking position and a releasing position, having an pushing portion and a blocking portion; wherein when the pushing assembly is in the locking position, the restriction portion blocks a path along which the blocking portion moves toward the blade-projecting end, the pushing portion is restrictedly unpushable toward the blade-projecting end to push the pushed portion so that the blade is unallowable to project out of the blade-projecting end; when the pushing assembly is in the releasing position, the restriction portion is located out of the path along which the blocking portion moves toward the blade-projecting, the pushing portion is movable toward the blade-projecting end to abut against the pushed portion to drive the blade projecting out of the blade-projecting end.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a preferred embodiment of the present invention;

FIG. 2 is a partial breakdown view of the preferred embodiment of the present invention;

FIG. 3 is a breakdown view of the preferred embodiment of the present invention;

FIG. 4 is a cross-sectional view of preferred embodiment of the present invention;

FIG. 5 is a partial cross-sectional view of the preferred embodiment of the present invention;

FIG. 6 is a cross-sectional view of the preferred embodiment of the present invention, taken along line 6-6 in FIG. 4;

FIG. 7 is a drawing showing an operation of the preferred embodiment of the present invention;

FIG. 8 is drawing showing the preferred embodiment of the present invention in use;

FIG. 9 is drawing showing detachment of the preferred embodiment of the present invention; and

FIGS. 10 and 11 are drawings of another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

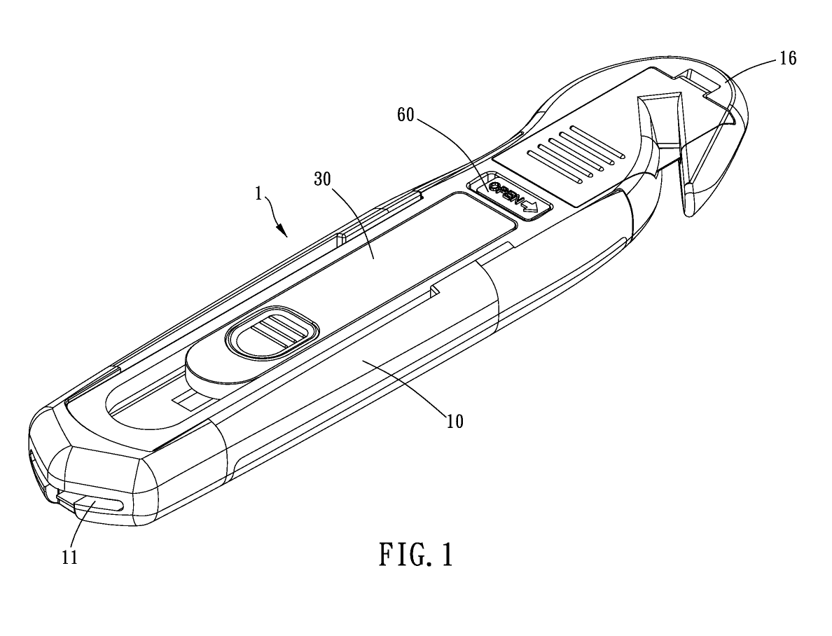

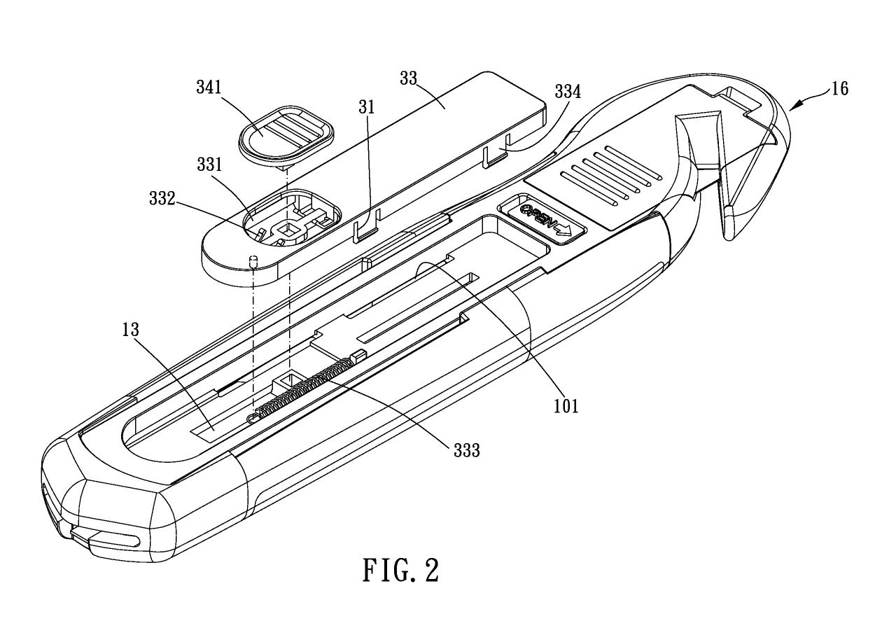

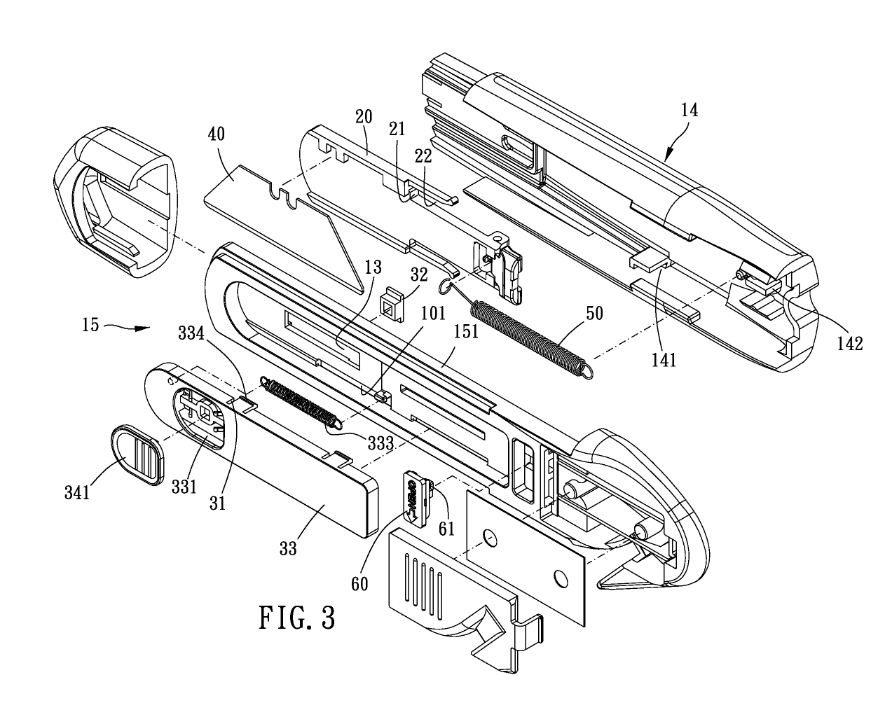

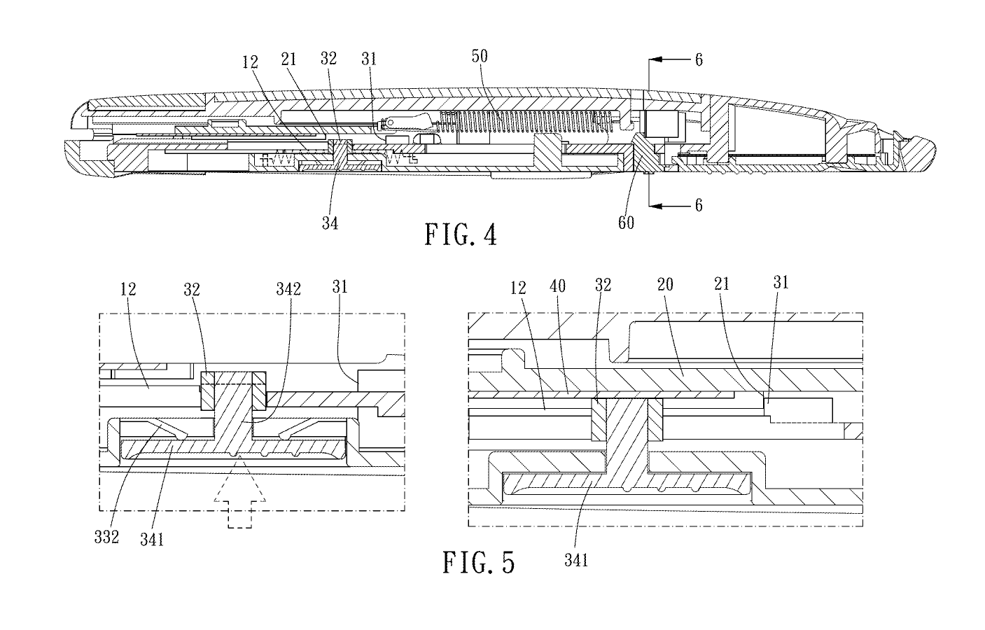

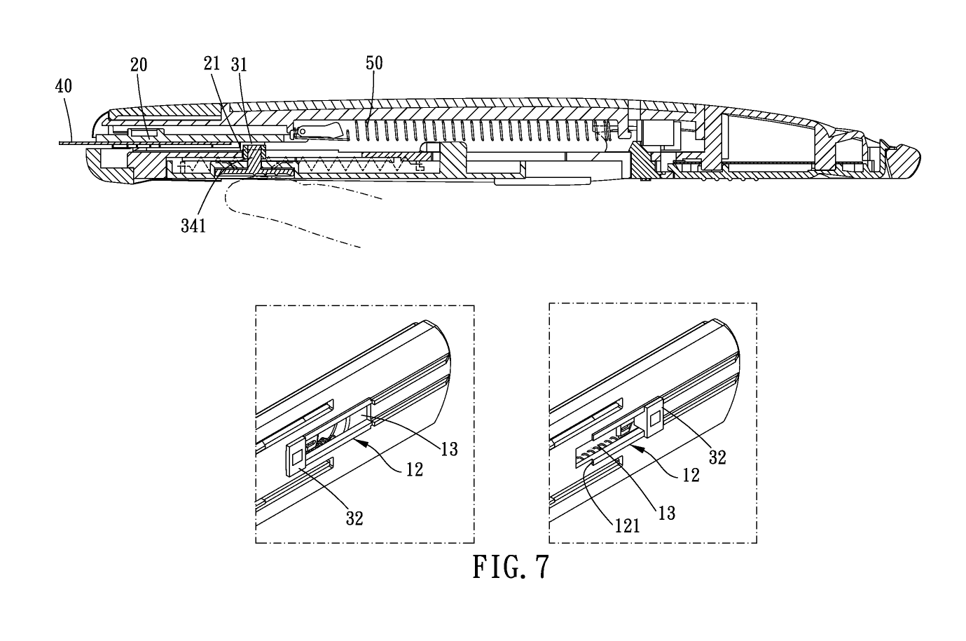

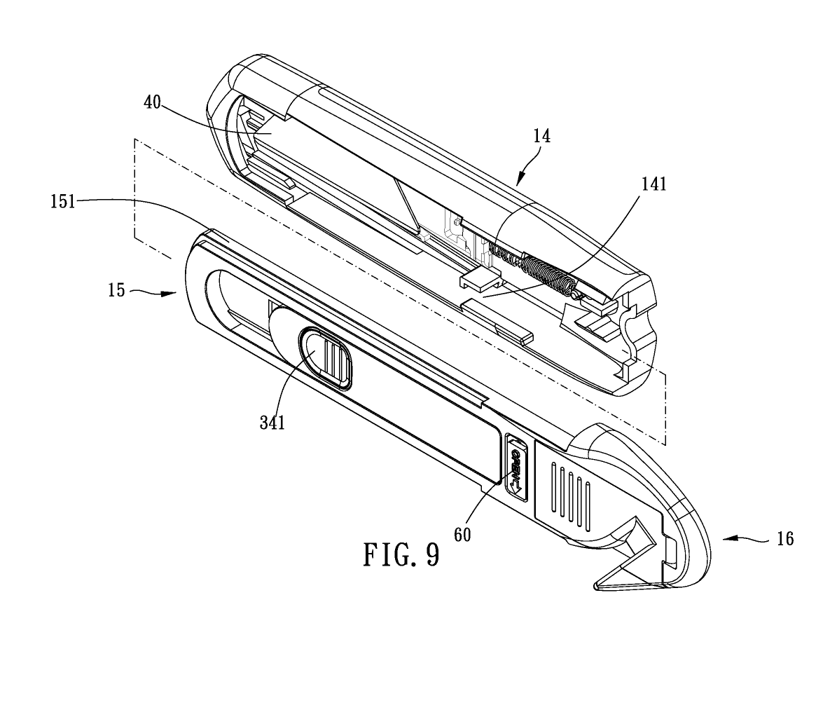

Please refer to FIGS. 1 to 8 for a preferred embodiment of a box cutter structure 1 of the present invention. The box cutter structure 1 includes a shell 10, a blade carrier 20 and a pushing assembly 30.

The shell 10 has a blade-projecting end 11 and a restriction portion 12. Specifically, the shell 10 is protrudingly formed with the restriction portion 12 on an inner face thereof and penetratingly formed with at least one guiding slot 13.

The blade carrier 20 is slidably disposed in the shell 10 and provided for carrying a blade 40. The blade carrier 20 further has a pushed portion 21. Specifically, each of two sides of the blade carrier 20 in a width direction is formed with a channel 22, and a wall of the channel 22 forms the pushed portion 21. However, the pushed portion 21 can be a convex structure, a concave structure or other abuttable structures, or the pushed portion 21 can be disposed on any protruding structures of the blade carrier 20.

The pushing assembly 30 is disposed on the shell 10 and operable from outside the shell 10 to move between a locking position and a releasing position. The pushing assembly 30 further has a pushing portion 31 and a blocking portion 32. In this embodiment, the pushing assembly 30 includes a carrying body 33 which is slidably disposed on the shell 10 and a pressing member 34 which is elastically and repositionably disposed through the carrying body 33. The carrying body 33 has the pushing portion 31, and the pressing member 34 has the blocking portion 32. Preferably, an elastic member 333 is further connected with the carrying body 33 and the shell 10. The elastic member 333 has the tendency to make the pushing assembly 30 move in a direction opposite to the blade-projecting end 11 so as to ensure that the pushing assembly 30 stays in the locking position normally. Specifically, the carrying body 33 is recessed with a receiving slot 331, and an elastic recovery mechanism 332 is disposed in the receiving slot 331. The restriction portion 12 includes at least one blocking face 121 which is disposed on a lateral side of the guiding slot 13 in a longitudinal direction; for example, each corresponding lateral side of the guiding slot 13 in the longitudinal direction is formed with a protruding rib, and an distal end of each protruding rib forms the blocking face 121. The pressing member 34 includes a pressing board 341 which is received in the receiving slot 331 and disposed above the elastic recovery mechanism 332 and a pillar portion 342 which is provided on a side of the pressing board 341 and disposed through the guiding slot 13. An end of the pillar portion 342 opposite to the pressing board 341 is formed with the blocking portion 32, and the blocking portion 32 is detachably disposed on the pillar portion 342. The elastic recovery mechanism 332 includes, for example, a plurality of elastic arms to provide even and appropriate recovery elasticity to the pressing member 34. The at least one blocking face 121 is blockable on a path along which the blocking portion 32 moves toward the blade-projecting end 11. The shell 10 is formed with at least one sliding hole 101. The carrying body 33 further has at least one lug 334 which penetrates through and protrudes outside the at least one sliding hole 101, and the lug 334 has the pushing portion 31. In this embodiment, the carrying body 33 has a plurality of sliding holes 101 and the lugs 334, and the two lugs 334 near the blade-projecting end 11 are formed with the pushing portion 31.

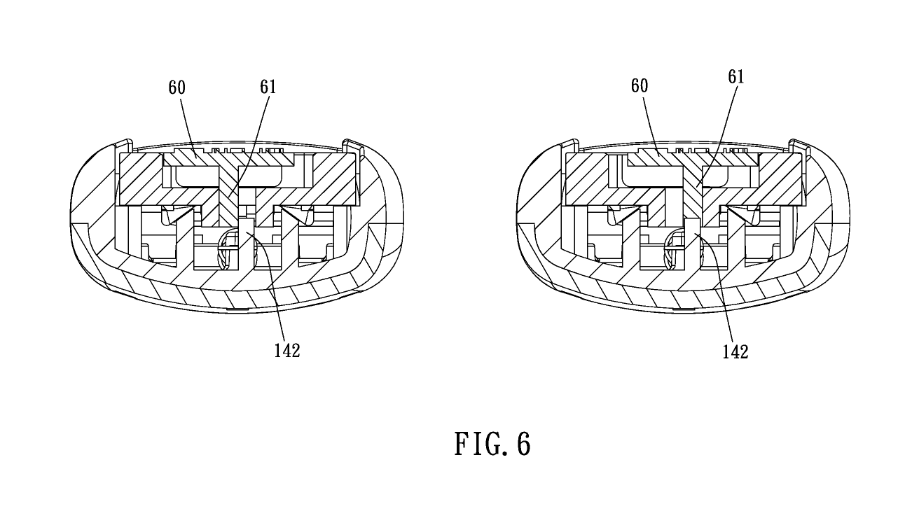

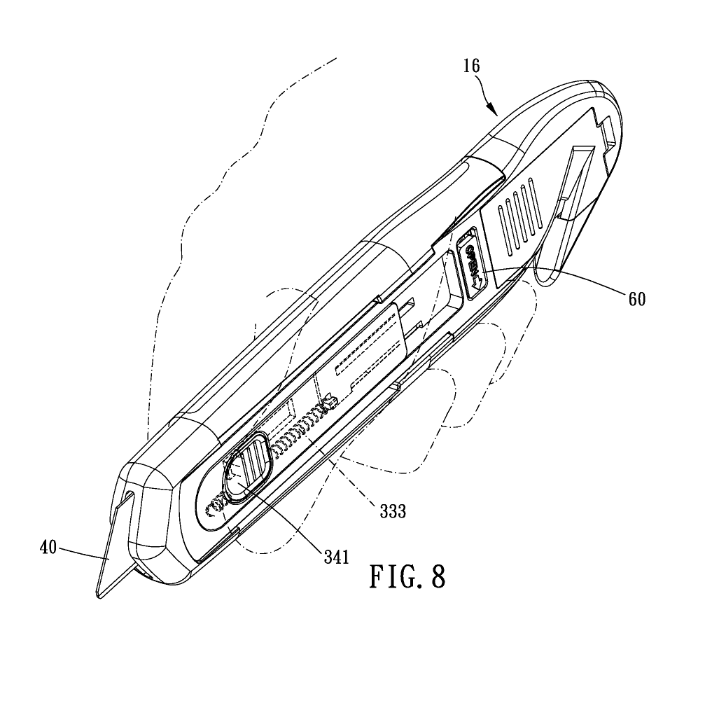

When the pushing assembly 30 is in the locking position, the restriction portion 12 blocks the path along which the blocking portion 32 moves toward the blade-projecting end 11 (please refer to FIGS. 5 and 7). The pushing portion 31 is restrictedly unpushable toward the blade-projecting end 11 to push the pushed portion 21 so that the blade 40 is unallowable to project out of the blade-projecting end 11. When the pressing board 341 is pressed, the blocking portion 32 disposed on the pillar portion 342 moves downward and away from an original position where the blocking portion 32 is blocked by the restriction portion 12 protrudingly disposed in the shell 10, the pushing assembly 30 is in the releasing position, the restriction portion 12 is located out of the path along which the blocking portion 32 moves toward the blade-projecting end 11 (please refer to FIGS. 5 and 7), the pushing assembly 30 is movable relative to the shell 10, and the pushing portion 31 is movable toward the blade-projecting end 11 and abuts the pushed portion 21 to drive the blade 40 projecting out of the blade-projecting end 11. Thereby, unless the pushing assembly 30 is actuated by a force to make the restriction portion 12 out of the path along which the blocking portion 32 moves toward the blade-projecting end, the blade 40 is unallowable to project out of the blade-projecting end 11.

Preferably, an elastic member 50 is further connected with the shell 10 and the blade carrier 20, and the elastic member 50 has a tendency to make the blade carrier 20 move in the direction opposite to the blade-projecting end 11. Therefore, after the blade 40 is projected and the pushing assembly 30 is released, the elastic member 50 pulls the blade carrier 20 back and retracts the blade 40 automatically to prevent the user from being cut accidentally. The elastic member 50 may be an annular spring, an extension spring or a compression spring according to various requirements.

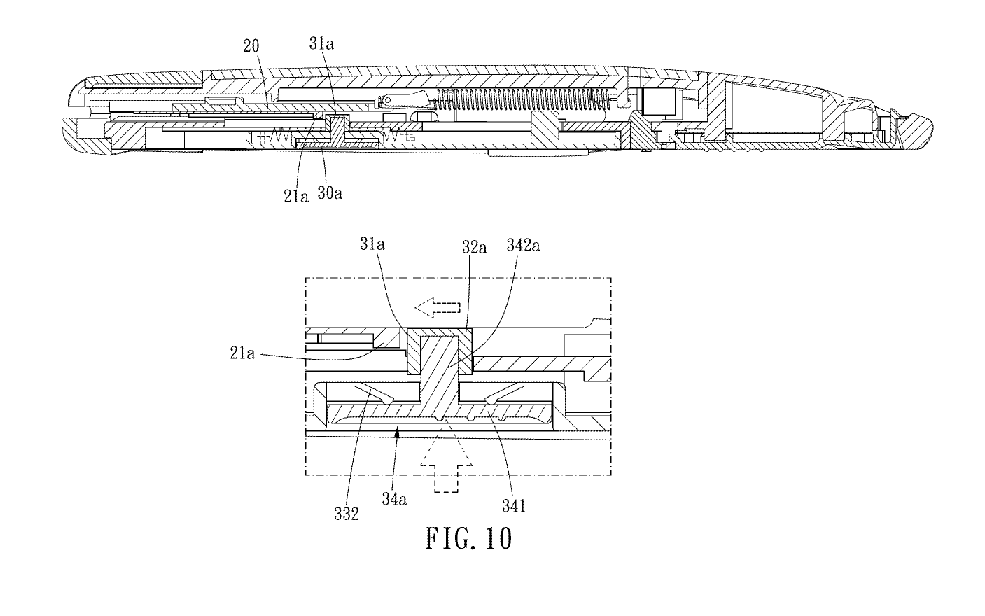

Please further refer to FIGS. 1 and 9. The box cutter structure 1 can be a two-way structure, wherein the shell 10 includes a main body 14 and a secondary body 15, the secondary body 15 has a work head 16 which is provided for processing an object (for example, a cutter for Bubble Wrap, but not limited thereto). One of the main body 14 and the secondary body 15 has an engaging slot 141, and the other has an engaging protruding flange 151 which is engageable with the engaging slot 141. In this embodiment, the main body 14 has the engaging slot 141, and the secondary body 15 has the engaging protruding flange 151; however, the main body 14 and the secondary body 15 may be provided with other similar structures, so the user can assemble, disassemble or replace members easily. The pushing assembly 30 is disposed on the secondary body 15, and a locking member 60 which is switchable from outside is further disposed on the secondary body 15. The locking member 60 has a stop portion 61 which selectively blocks a stuck portion 142 of the main body 14 on a path along which the secondary body 15 moves in a direction opposite to the main body 14; therefore, when the box cutter structure 1 is used, the secondary body 15 can be prevented from being pushed accidentally and from falling off from the main body 14. In addition, when the work head 16 is used, a force is put on the secondary body 15 to make the secondary body 15 move toward the blade-projecting end 11, and the blocking portion 32 blocked by the restriction portion 12 can prevent the pushing assembly 30 from being pushed and prevent the blade 40 from projecting out.

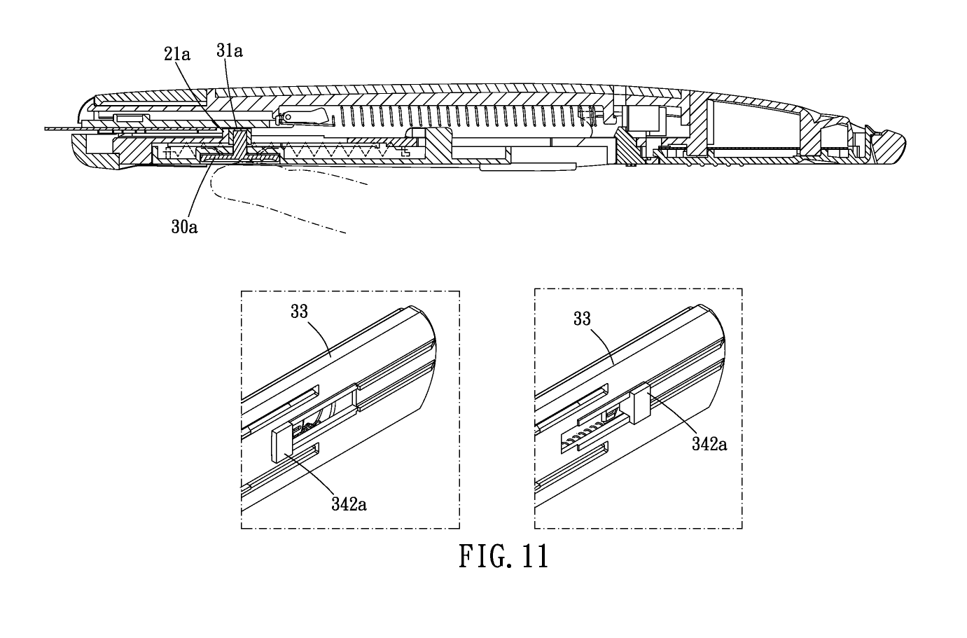

In another embodiment as shown in FIGS. 10 and 11, a pressing member 34a of a pushing assembly 30a has a pushing portion 31a and a blocking portion 32a, and a blade carrier 20a is protrudingly formed with a pushed portion 21a. Specifically, the pressing member 34a includes a pressing board 341 which is disposed above the elastic recovery mechanism 332 and a pillar portion 342a which is provided on a side of the pressing board 341 and disposed through the carrying body 33. An end of the pillar portion 342a opposite to the pressing board 341 is formed with the pushing portion 31a and the blocking portion 32a. After the pressing member 34a is pressed, the pushing portion 31a of the pillar portion 342a pushes the blade carrier 20a to project the blade 40.

Given the above, with an engagement of the blocking portion disposed on the pushing assembly and the restriction portion disposed in the shell, the restriction portion needs to be located out of the path along which the blocking portion moves toward the blade-projecting end first so that the blade can project out of the blade-projecting end.

In addition, with the elastic members, the blade can be retreated automatically.

Furthermore, the two-way structure is preferably formed with the locking member to prevent the pushing assembly disposed on the secondary body from being pushed and prevent the blade from projecting out.

While we have shown and described various embodiments in accordance with the present invention, it should be clear to those skilled in the art that further embodiments may be made without departing from the scope of the present invention.

What is claimed is:

1. A box cutter structure, including:
a shell, having a blade-projecting end and a restriction portion;
a blade carrier, slidably disposed in the shell and provided for carrying a blade, having a pushed portion;
a pushing assembly, disposed on the shell, being operable from outside the shell to move between a locking position and a releasing position, having an pushing portion and a blocking portion;
wherein, when the pushing assembly is in the locking position, the restriction portion blocks a path along which the blocking portion moves toward the blade-projecting end, the pushing portion is restrictedly unpushable toward the blade-projecting end to push the pushed portion so that the blade is unallowable to project out of the blade-projecting end;
when the pushing assembly is in the releasing position, the restriction portion is located out of the path along which the blocking portion moves toward the blade-projecting end, the pushing portion is movable toward the blade-projecting end to abut against the pushed portion to drive the blade projecting out of the blade-projecting end.

2. The box cutter structure of claim 1, wherein the pushing assembly further includes a carrying body which is slidably disposed in the shell and a pressing member which is elastically repositionably disposed in the carrying body, the carrying body has the pushing portion, and the pressing member has the blocking portion.

3. The box cutter structure of claim 2, wherein the carrying body is recessed with a receiving slot, the receiving slot has an elastic recovery mechanism, the shell is further penetratingly formed with a guiding slot, the pressing member includes a pressing board which is received in the receiving slot and disposed above the elastic recovery mechanism and a pillar portion which is provided on a side of the pressing board and disposed through the guiding slot, and an end of the pillar portion opposite to the pressing board is formed with the blocking portion.

4. The box cutter structure of claim 3, wherein the shell is protrudingly formed with the restriction portion on an inner face thereof and penetratingly formed with at least one sliding hole, the restriction portion includes at least one blocking face on a lateral side of the guiding slot in a longitudinal direction, the at least one blocking face blocks the path along which the blocking portion moves toward the blade-projecting end, the carrying body further has at least one lug which is disposed through and protrudes out of the at least one sliding hole, and the at least one lug has the pushing portion.

5. The box cutter structure of claim 1, wherein the pushing assembly includes a carrying body which is slidably disposed on the shell and a pressing member which is elastically repositionably disposed through the carrying body, and the pressing member has the pushing portion and the blocking portion.

6. The box cutter structure of claim 5, wherein the shell is protrudingly formed with the restriction portion on an inner face thereof, the blade carrier is protrudingly formed with the pushed portion, the pressing member includes a pressing board which is disposed above the elastic recovery mechanism and a pillar portion which is provided on a side of the pressing board and disposed through the carrying body, and an end of the pillar portion opposite to the pressing board is formed with the pushing portion and the blocking portion.

7. The box cutter structure of claim 1, wherein an elastic member is further connected with the pushing assembly and the shell, and the elastic member has a tendency to move the pushing assembly toward a direction opposite to the blade-projecting end.

8. The box cutter structure of claim 1, wherein the shell includes a main body and a secondary body, the secondary body has a work head which is provided for processing an object, one of the main body and the secondary body has an engaging slot, and the other has an engaging protruding flange which is engageable with the engaging slot.

9. The box cutter structure of claim 8, wherein the pushing assembly is disposed on the secondary body.

10. The box cutter structure of claim 8, wherein the secondary body is further formed with a locking member which is switchable from outside, and the locking member has a stop portion which is selectively blockable with the main body on a path along which the secondary body moves toward a direction opposite to the main body.
